(19) United States
(12) Patent Application Publication
(10) Pub. No.: US 2010/0200475 A1
(43) Pub. Date: Aug. 12, 2010

(54) WASTE WATER TREATMENT SYSTEM USING DISTRIBUTION MANIFOLD

(76) Inventor: Young-Bok KWON, Suwon-si (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/694,015

(22) Filed: Jan. 26, 2010

(30) Foreign Application Priority Data
Feb. 11, 2009 (KR) 10-2009-0010979

(51) Int. Cl. B01D 35/157

(52) U.S. Cl. 210/86

(57) ABSTRACT

The waste water treatment system using a distribution manifold comprises a source water storing tank for storing waste water; a drum screen which filters the source water inputted from the source water storing tank through a first transfer pump P1 and eliminates foreign substances of above 0.5 mm; a pH adjusting tank which has a chemical mixing unit formed of a pH sensor for sensing the pH value for adjusting the pH value through chemicals after the source water inputted through the transfer pipe is stored in a state that the foreign substances are removed by the drum screen and an agitating wing for mixing chemicals, and a storing unit for storing the source water inputted from the chemical mixing unit by an upward movement, with the pH value of the source water being adjusted; and a manifold mixing tank which has a chemical input port, a static mixer, a pH sensor in the horizontal position of the horizontal pipe H, so that the source water of the storing unit is inputted through the second transfer pump P2, and chemicals are laminar-mixed by means of the manifold in which pluralities of horizontal pipes H and vertical pipes L are connected with one another in zigzag shapes and are arranged in upper and lower structures.

### TECHNICAL FIELD

The present invention relates to a waste water treatment system, and in particular to a waste water treatment system using a distribution manifold which is capable of more simply and stably treat waste water based on a mechanical and chemical waste treatment system.

### BACKGROUND ART

Air pollution as well as water pollution continues to worsen and worsen due to a poor recognition on environment as industrialization advances fast. In particular industrial waste water, livestock waste water, life waste water pollute lake, inner sea and outer sea and small and big rivers in cities and towns.

The pollutant can be classified into a point pollution source and a non-point pollution source.

The point pollution source means pollutants which are produced from a defined or limited area such as life waste water, industrial waste water, livestock waste water, etc.

The non-point pollution source means pollutants which are produced wider non-defined areas such as agricultural area, grass field, forest area, building construction site, mine area, logging area, waste treatment site, waste burying area, city area, industrial area, etc.

The pollutants produced from the above pollution sources are heavy metals, pathogenic microorganism, organic compound, radioactive substances, toxic substances, etc. which are inputted into ground surface or underground water while polluting water and soil.

In recent years, a water treatment system is forcibly installed in a corresponding area so as to overcome such pollutants. As a method for treating pollutants, a mechanical method, a chemical method, a biological method or a combination of the above methods are used.

However, the above treatment method costs a lot for installation, and in the course of treatment, it is needed to select a certain treatment apparatus and method which matches with a pollutant. When different pollutants are produced from different pollutants, it is impossible to treat such different pollutants, In order to overcome the above problems, further apparatuses are needed.

In other words, in case of the conventional mechanical chemical treatment system, 3 or 4 sets of large size tanks are needed for chemical mixing in the course of condensation for eliminating the pollutants from waste water. In this case, wider areas are needed for tank installations, which need a higher cost. Even when some error occurs in the course of condensation, a stable water treatment cannot be guaranteed since there are not further sensing and safety apparatuses.

### DISCLOSURE OF THE INVENTION

Accordingly, it is an object of the present invention to provide a waste water treatment system using a distribution manifold.

It is another object of the present invention to provide a waste water treatment system using a distribution manifold in which source water flows fast through a manifold in the course of pre-treatment, and water is treated by mechanical and chemical methods with the help of chemicals inputted through a manifold at set points, and the source water treated in the course of post-treatment is forced to be turbulent flow and laminar flow for thereby discharging only stabilized and treated water.

To achieve the above objects, there is provided a waste water treatment system using a distribution manifold which comprises a source water storing tank for storing waste water; a drum screen which filters the source water inputted from the source water storing tank through a first transfer pump P1 and eliminates foreign substances of above 0.5 mm; a pH adjusting tank which has a chemical mixing unit formed of a pH sensor for sensing the pH value for adjusting the pH value through chemicals after the source water inputted through the transfer pipe is stored in a state that the foreign substances are removed by the drum screen and an agitating wing for mixing chemicals, and a storing unit for storing the source water inputted from the chemical mixing unit by an upward movement, with the pH value of the source water being adjusted; a manifold mixing tank which has a chemical input port, a static mixer, a pH sensor in the horizontal position of the horizontal pipe H, so that the source water of the storing unit is inputted through the second transfer pump P2, and chemicals are laminar-mixed by means of the manifold in which pluralities of horizontal pipes H and vertical pipes L are connected with one another in zigzag shapes and are arranged in upper and lower structures; a precipitation tank which makes turbulent flow in the source water discharged from the upper most horizontal pipe H of the manifold mixing tank and at the same time makes laminar flow for thereby separating sludge and treatment water; and a sludge concentration tank for inputting the sludge precipitated in the precipitation tank through the third transfer pump P3, wherein return valves are installed in the transfer pipe connected from the drum screen to the pH adjusting tank and the upper most horizontal pipe H of the manifold mixing tank, and the return valves are connected via the return pipe.

### EFFECTS

In the waste water treatment system using a distribution manifold according to the present invention, source water flows fast through a manifold in the course of pre-treatment, and water is treated by mechanical and chemical methods with the help of chemicals inputted through a manifold at set points, and the source water treated in the course of post-treatment is forced to be turbulent flow and laminar flow for thereby discharging only stabilized and treated water.

### BRIEF DESCRIPTION OF THE DRAWINGS

The present invention will become better understood with reference to the accompanying drawings which are given only by way of illustration and thus are not limitative of the present invention, wherein;

FIG. 1 is a view of the construction of a waste treatment system using a distribution manifold according to the present invention;

FIG. 2 is an enlarged view of the manifold mixing tank of FIG. 1;

FIG. 3 is a side view of FIG. 2;

FIG. 4 is an enlarged cross sectional view of the precipitation tank of FIG. 1;

FIG. 5 is a plane view of FIG. 4; and

FIG. 6 is an enlarged view of a certain portion of FIG. 5.

### MODES FOR CARRYING OUT THE INVENTION

The preferred embodiments of the present invention will be described with reference to the accompanying drawings.

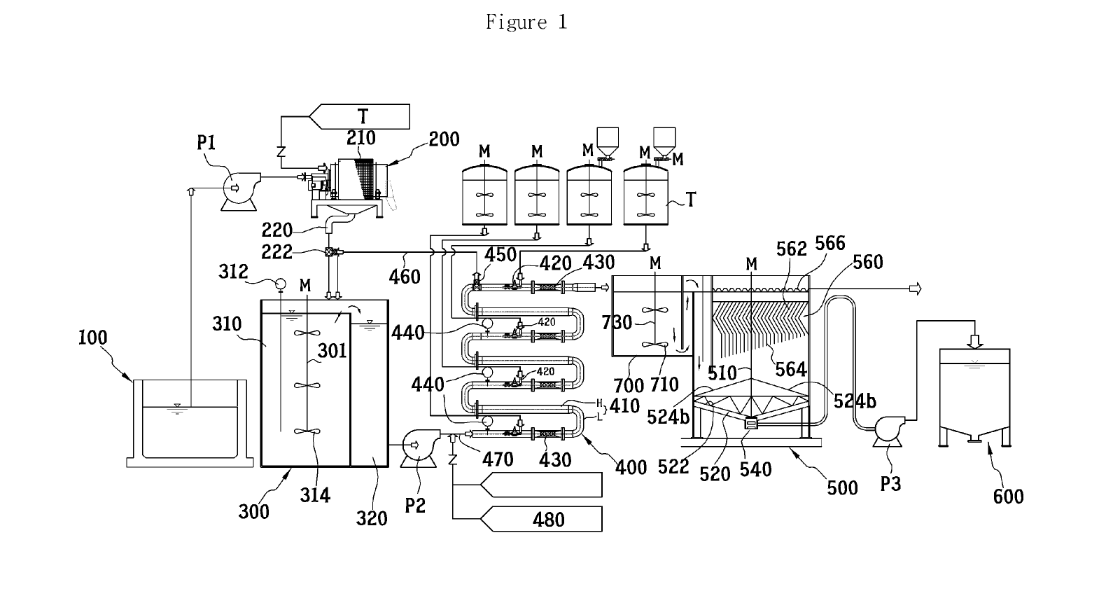

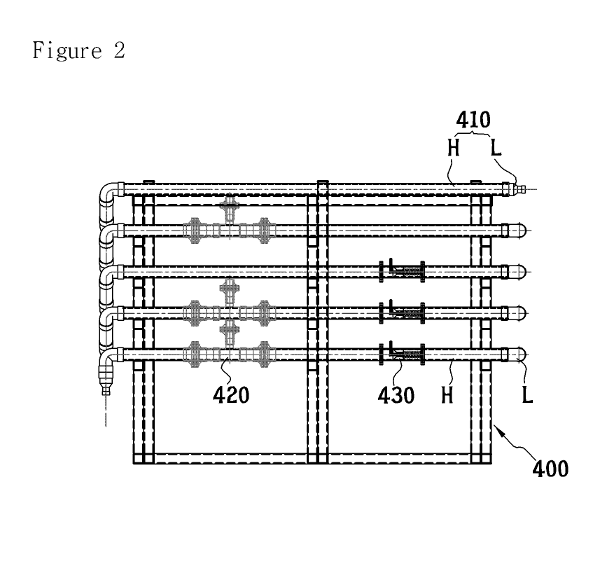

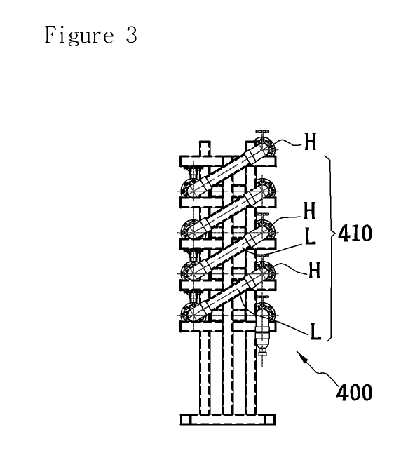

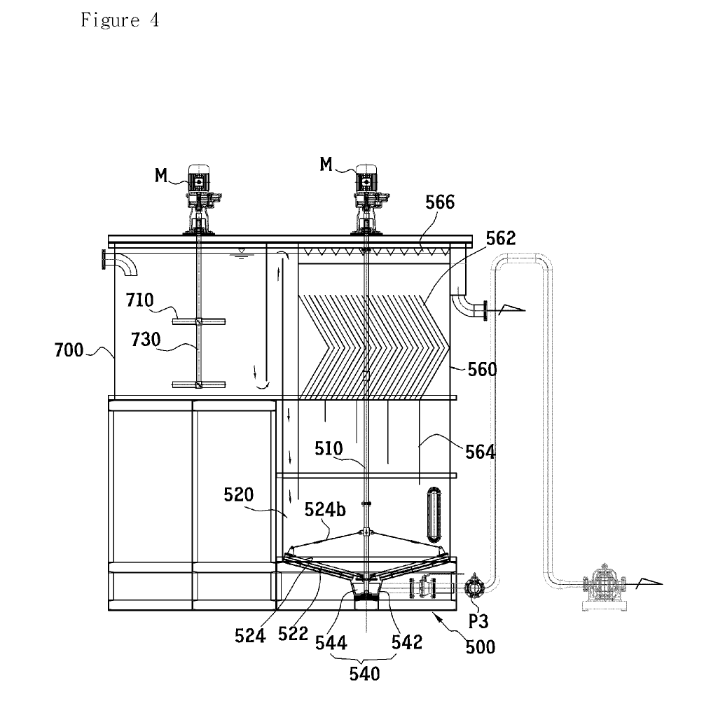

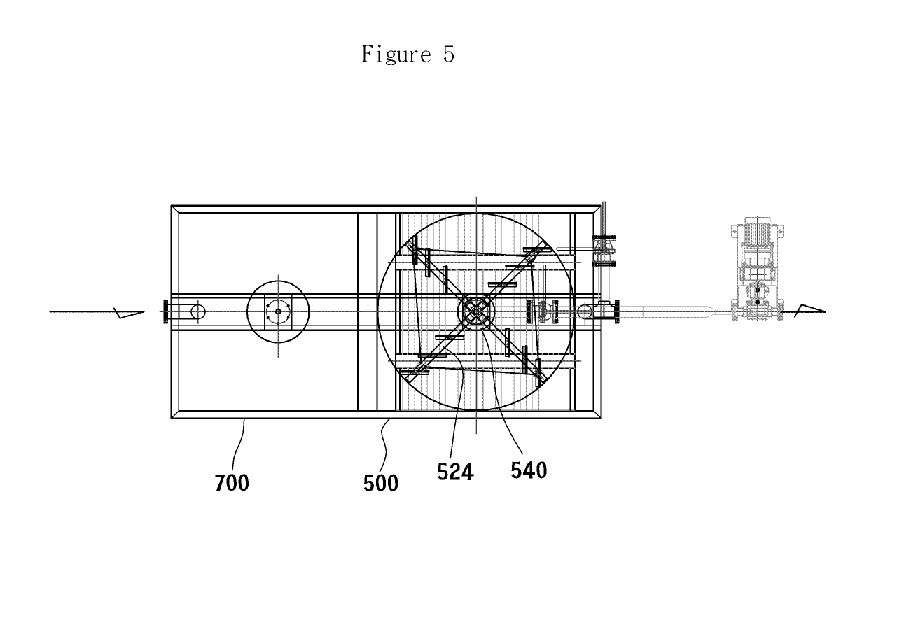

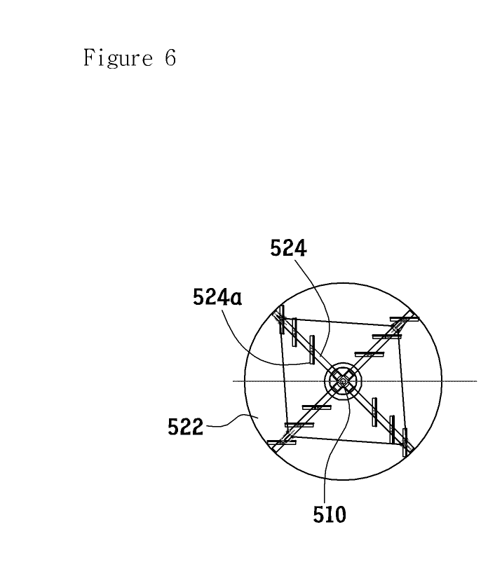

As shown in FIGS. 1 through 6, the waste water treatment system using a distribution manifold, comprises a source water storing tank 100 for storing waste water; a drum screen 200 which filters the source water inputted from the source water storing tank 100 through a first transfer pump P1 and eliminates foreign substances of above 0.5 mm; a pH adjusting tank 300 which has a chemical mixing unit 310 formed of a pH sensor 312 for sensing the pH value for adjusting the pH value through chemicals after the source water inputted through the transfer pipe 220 is stored in a state that the foreign substances are removed by the drum screen 200 and an agitating wing 314 for mixing chemicals, and a storing unit 320 for storing the source water inputted from the chemical mixing unit 310 by an upward movement, with the pH value of the source water being adjusted; a manifold mixing tank 400 which has a chemical input port 420, a static mixer 430, a pH sensor 440 in the horizontal position of the horizontal pipe H, so that the source water of the storing unit 320 is inputted through the second transfer pump P2, and chemicals are laminar-mixed by means of the manifold 410 in which pluralities of horizontal pipes H and vertical pipes L are connected with one another in zigzag shapes and are arranged in upper and lower structures; a precipitation tank 500 which makes turbulent flow in the source water discharged from the upper most horizontal pipe H of the manifold mixing tank 400 and at the same time makes laminar flow for thereby separating sludge and treatment water; and a sludge concentration tank 600 for inputting the sludge precipitated in the precipitation tank 500 through the third transfer pump P3, wherein return valves 222 and 450 are installed in the transfer pipe 220 connected from the drum screen 200 to the pH adjusting tank 300 and the upper most horizontal pipe H of the manifold mixing tank 400, and the return valves 222 and 450 are connected via the return pipe 460.

The source storing tank 100 has an open upper side for thereby storing waste water therein inputted from the open side.

The drum screen 200 is formed in a known way and consists of a motor and a rotation net body 210 which rotates by the driving force of the motor and has a plurality of pores on its surface. When the rotation net body 210 rotates, relatively large size substances can be filtered from the waste water inputted into the rotation net body 210.

The source water inputted into the source water storing tank 100 through the first transfer pump P1 is filtered by the rotation net body 210 for thereby filtering foreign substances of larger than 0.5 mm.

The pH adjusting tank 300 stores the source water inputted through the transfer pipe 220 after the foreign substances are removed by the drum screen 200, and includes a pH sensor 312 for sensing the pH value so as to adjust pH value with chemicals, a chemical mixing unit 310 having agitation wings 314 for mixing chemicals, and a storing unit 320 for storing the pH-adjusted source water inputted from the chemical mixing unit 310 for the upward movement.

The agitation wing 314 rotates along with the rotation of the rotary shaft 301 connected with the motor M for thereby mixing chemicals and source water.

The pH sensor 312 sets the pH value at a target value for thereby obtaining a faster source water treatment.

Chemicals T are selectively inputted into the drum screen 200 and the chemical mixing unit 310 of the pH adjusting tank 300 for concentration of sludge.

The source water of the storing unit 320 is inputted into the manifold mixing tank 400 through the second transfer pump P2, and chemicals are mixed through the manifold 410 formed of pluralities of horizontal pipes H and vertical pipes L in zigzag forms, and the chemical input port 420, the static mixer 430 and the pH sensor 440 are installed in the horizontal pipe H.

The liquid chemical stored in the chemical storing tank T is selectively inputted into the chemical input port 420 installed in the horizontal pipe H.

Return valves 222 and 450 are installed in the transfer pipe 220 connected from the drum screen 200 to the pH adjusting unit 300 and the upper most horizontal pipe H of the manifold mixing tank 400. The return valves 222 and 450 are connected with the return pipe 460.

With the above construction, the water is circulated again when a desired pH value is not obtained.

An ozone water supply valve 480 can be further installed in the transfer pipe 470 which guides the source water from the second transfer pump P2 to the manifold mixing tank 400.

The precipitation 500 includes a turbulent guide unit 520 for guiding turbulent flow in the source water discharged from the upper most horizontal pipe H of the manifold mixing tank 400, a precipitation unit 540 disposed in the lower side of the turbulent flow guide unit 520 for precipitating a solid substance, and a laminar flow guide unit 560 which is disposed in the upper side of the turbulent flow guide unit 520 for converting the turbulent source water into laminar flow water and discharging to a certain place.

The turbulent flow guide unit 520 includes a condensation plate 522 disposed in the lower side of the body belonging to the precipitation tank 500 for moving the condensed substance to the center portion with the help of inclined angle, and a plurality of blade units 524 which are provided on the upper surface of the condensation plate 522 for agitating the sludge dropping from the upper side of the condensation plate 522 during the rotation by the driving force of the motor M.

A plurality of blades 524a are engaged to the lower side of each blade unit 524 for moving the sludge toward the precipitation unit 40 with the help of its set angle when the blade units 524 rotate.

The blade unit 524 is configured with its one end being connected with the rotary shaft 510 connected with the motor M and with the other end being connected with an elastic member 524b connected with the rotary shaft 510, so the blade unit 524 is closely and elastically contacted with the upper surface of the concentration plate 522.

The laminar flow guide unit 560 includes laminar flow guide plates 562 for forming treatment water guide paths between them with opposite inclined angles in the upper and lower sides of the precipitation tank 500, a plurality of skirt plates 564 which are vertically installed with different upper and lower lengths in the lower sides of the laminar flow guide plates 562 for thereby vertically guiding source water, and a treatment water guide plate 566 disposed in the upper side of the precipitation tank 500 for moving the treatment water in one direction.

The precipitation unit 540 is provided in the center of the condensation plate 522 and inputs the sludge moved along the inclined angle of the condensation plate 522.

The precipitation unit 540 in the precipitation tank 500 includes a storing box 542 disposed in the lower side of the casing belonging to the precipitation tank 500 for inputting the sludge moved along the inclined angle of the condensation plate 522, and a plurality of transfer wings 544 which are disposed in the storing box 542 and rotate when the rotary shaft 510 rotates for thereby pushing the sludge toward the condensation tank 600.

A mixing tank 700 is further installed in the inlet of the precipitation tank 500 and includes an agitation wing 710 rotating by the driving force of the motor M for thereby mixing the source water inputted from the manifold mixing tank 400 with chemicals.

The agitation wing 710 rotates by the rotation of the rotary shaft 730 connected with the motor M for thereby mixing treatment water.

An ozone water supply valve 480 is further installed in the transfer pipe 470 for guiding the source water to the manifold mixing tank 400 through the second transfer pump P2.

The sludge concentration tank 600 receives the sludge precipitated in the precipitation unit 540 through the third transfer pump P3 and stores the same.

The operation of the water treatment system using a distribution manifold according to the present invention will be described.

When waste water is inputted into the source water storing tank 100, the first transfer pump P1 operates, and the source water is moved from the source water storing tank 100 to the drum screen 200, and the inputted source water is filtered by the rotation net body 210. Foreign substances of above 0.5 mm are filtered. The source water is inputted into the chemical mixing unit 310 of the pH adjusting tank 300 through the transfer pipe 220 in a foreign substance-removed state. Chemicals and treatment water are mixed by the rotation of the agitation wing 314. Chemical-mixed treatment water is upwardly moved to the storing unit 320 in overflowing states, and the treatment water moved to the storing unit 320 is inputted into the manifold mixing tank 400 through the second transfer tank P2.

The treatment water inputted into the chemical mixing unit 310 is moved with a proper pH value by means of the pH sensor 312.

The treatment water passes through the horizontal and vertical pipes H and L in zigzag forms while being mixed through the chemical input port 420 installed at each section and the static mixer 430, and are treated through the pH value sensing process with the help of the pH sensor 440.

At this time, when the pH value is below the standard value by means of the pH sensor 440, it is circulated again through the return pipe 460.

The treatment water, which was continuously treated chemically, is moved to the mixing tank 700 and is performed the chemical mixing process, and the treatment water substantially mixed in the mixing tank 700 is inputted into the precipitation tank 500.

The treatment water inputted into the precipitation tank 500 is processed to have turbulent flow and is at the same time processed to have laminar flow for thereby separately discharging sludge and treatment water.

When the inputted treatment water is placed in the lower side of the body belonging to the precipitation tank 500, heavy concentrated sludge is moved to the center portion along the inclined angle of the concentration plate 522, and the sludge dropped on the concentration plate 522 is turbulent-formed by means of the blade units 524 rotating along with the rotation of the rotary shaft 510 with the help of the driving force of the motor M, and heavier sludge is moved to the precipitation unit 540, and turbulent flow occurs in the treatment water, and the water moves upwards.

The moving treatment water collides with the skirt plates 564 while forming laminar flow and moving vertically and moves upwards through between the laminar guide plates 562 and passes through the treatment water guide plate 566 and moves outwards.

The sludge moving along the inclined angle of the condensation plate 522 drops downwards into the storing box 542 and at the same time is moved to the sludge concentration tank 600 by means of the rotation of the transfer wings 544 provided in the storing box 542 and is treated therein.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A waste water treatment system using a distribution manifold, comprising:
a source water storing tank 100 for storing waste water;
a drum screen 200 which filters the source water inputted from the source water storing tank 100 through a first transfer pump P1 and eliminates foreign substances of above 0.5 mm;
a pH adjusting tank 300 which has a chemical mixing unit 310 formed of a pH sensor 312 for sensing the pH value for adjusting the pH value through chemicals after the source water inputted through the transfer pipe 220 is stored in a state that the foreign substances are removed by the drum screen 200 and an agitating wing 314 for mixing chemicals, and a storing unit 320 for storing the source water inputted from the chemical mixing unit 310 by an upward movement, with the pH value of the source water being adjusted;
a manifold mixing tank 400 which has a chemical input port 420, a static mixer 430, a pH sensor 440 in the horizontal position of the horizontal pipe H, so that the source water of the storing unit 320 is inputted through the second transfer pump P2, and chemicals are laminar-mixed by means of the manifold 410 in which pluralities of horizontal pipes H and vertical pipes L are connected with one another in zigzag shapes and are arranged in upper and lower structures;
a precipitation tank 500 which makes turbulent flow in the source water discharged from the upper most horizontal pipe H of the manifold mixing tank 400 and at the same time makes laminar flow for thereby separating sludge and treatment water; and
a sludge concentration tank 600 for inputting the sludge precipitated in the precipitation tank 500 through the third transfer pump P3, wherein return valves 222 and 450 are installed in the transfer pipe 220 connected from the drum screen 200 to the pH adjusting tank 300 and the upper most horizontal pipe H of the manifold mixing tank 400, and the return valves 222 and 450 are connected via the return pipe 460.

2. The system of claim 1, wherein an ozone water supply valve 480 is installed in a transfer valve 470 for guiding source water to the manifold mixing tank 400 through the second transfer pump P2.

3. The system of claim 1, wherein said precipitation tank 500 includes:
a turbulent flow guide unit 520 which has a condensation plate 522 provided in a lower side of the body belonging to the precipitation tank 500 for thereby moving the concentration substance to the center portion along the inclined angle, and a plurality of blade units 524 disposed on the upper surface of the concentration plate 522 for moving the sludge dropping onto the upper surface of the concentration plate 522 when the rotary shaft 510 rotates by the driving force of the motor M and forming turbulent flow in water;
a laminar flow guide unit 560 which has laminar guide plates 562 arranged in left and right sides with opposite inclined angles at upper and lower sides in the upper and lower sides of the precipitation tank 500 for thereby forming a treatment water guide path between them, a plurality of skirt plates 564 which are vertically provided in the lower sides of the laminar guide plates 562 for upwardly and vertically guiding the source water, and a treatment water guide plate 566 provided in the upper side of the precipitation tank 500 for moving the treatment water in one direction; and
a precipitation unit 540 which has a storing box 542 provided in the center of the concentration plate 522 for receiving the sludge moved along the inclined angle of the concentration plate 522, and a plurality of transfer wings 544 which are provided in the storing box 542 and rotates along with the rotation of the rotary shaft 510 for pushing the sludge toward the sludge concentration tank 600.

4. The system of claim 3, further comprising a mixing tank 700 which is provided in the inlet port of the precipitation tank 500 and is formed of agitating wings 710 which rotate by the driving force of the motor for thereby mixing the source water with chemicals.

5. The system of claim 3, wherein said skirt plate 564 has a length which is getting longer or shorter in one direction to another direction.
